(19) United States
(12) Patent Application Publication
(10) Pub. No.: US 2026/0316607 A1
(43) Pub. Date: Oct. 15, 2026

(54) ACTIVE POWER DECOUPLING

(71) Applicant: GM GLOBAL TECHNOLOGY OPERATIONS LLC, Detroit, MI (US)

(72) Inventors: Minh-Khai Nguyen, Troy, MI (US); Yilun Luo, Ann Arbor, MI (US); Khorshed Mohammed Alam, Canton, MI (US); Lei Hao, Troy, MI (US); Mohammad N. Anwar, Van Buren Twp., MI (US)

(73) Assignee: GM GLOBAL TECHNOLOGY OPERATIONS LLC, Detroit, MI (US)

(21) Appl. No.: 19/175,062

(22) Filed: Apr. 10, 2025

(51) Int. Cl. B60L 53/24; H02J 7/00; H02J 7/02; H02M 1/14

(52) U.S. Cl. CPC B60L 53/24; H02J 7/02; H02J 7/855; H02J 7/865; H02M 1/14

(57) ABSTRACT

An active power decoupling system includes a battery pack that stores electrical energy at a pack voltage, an onboard charging module operational to convert an alternating current line signal to a rectified signal that has a ripple, an inverter operational to convert the pack voltage into an alternating current signal while in a propulsion mode and transfer the rectified signal to the battery pack while in a charge mode, an electric motor operational to convert the alternating current signal into a rotational torque while in the propulsion mode and one or more windings is operational to filter the ripple in the rectified signal while in the charge mode, a capacitor coupled to the onboard charging module, and one or more switches operational to route the rectified signal through the capacitor and the one or more winding of the electric motor to filter the ripple while in the charge mode.

### INTRODUCTION

The present disclosure relates to a system and a method for active power decoupling.

Many modern electrified vehicles carry an on-board charger module that converts household electrical power into a form suitable for charging the vehicle batteries. The power conversion often produces a rectified signal that if left unfiltered accelerates degradation of the batteries. Therefore, filtering of the rectified signal is usually provided by a high capacitance output filter capacitor that occupies considerable space.

Accordingly, those skilled in the art continue with research and development efforts in the field of active power decoupling of a single-stage on-board charger module in a vehicle.

### SUMMARY

An active power decoupling system is provided herein. The system includes a battery pack, an onboard charging module, an inverter, an electric motor, a capacitor, and one or more switches. The battery pack is operational to store electrical energy at a pack voltage. The onboard charging module is coupled to the battery pack and is operational to convert an alternating current line signal to a rectified signal. The rectified signal has a ripple. The inverter is coupled to the onboard charging module and the battery pack. The inverter is operational to convert the pack voltage into a multi-phase alternating current signal while in a propulsion mode, and transfer the rectified signal to the battery pack while in a charge mode. The electric motor has a plurality of windings in multiple phases and is coupled to the inverter. The electric motor is operational to convert the multi-phase alternating current signal into a rotational torque while in the propulsion mode, and one or more windings of the plurality of windings is operational to filter the ripple in the rectified signal while in the charge mode. The capacitor is coupled to the onboard charging module. The one or more switches are coupled to the onboard charging module and operational to route the rectified signal through the capacitor and the one or more winding of the electric motor to filter the ripple while in the charge mode.

In one or more embodiments of the system, the capacitor is between the onboard charging module and the electric motor, the electric motor is a three-terminal machine, the one or more switches is a first switch between the capacitor and one terminal of the three-terminal machine, the first switch connects the capacitor to the one terminal while in the charge mode, and the first switch disconnects the capacitor from the one terminal while in the propulsion mode.

In one or more embodiments of the system, the capacitor is between the onboard charging module and the electric motor, the electric motor is a three-terminal machine, the one or more switches is two switches between the capacitor and two terminals of the three-terminal machine, respectively, the two switches connect the capacitor to one of the two terminals while in the charge mode, and the two switches disconnects the capacitor from the two terminals while in the propulsion mode.

In one or more embodiments of the system, the electric motor is a three-terminal machine, the one or more switches is two switches between the capacitor and two terminals of the three-terminal machine, respectively, the two switches connect the capacitor to one of the two terminals while in the charge mode, and the two switches disconnect the capacitor from the two terminals while in the propulsion mode.

In one or more embodiments of the system, the electric motor is a four-terminal machine with a common terminal, the one or more switches includes a first switch between the onboard charging module and the common terminal, the first switch connects the common terminal to the onboard charging module while in the charge mode, the first switch disconnects the common terminal from the onboard charging module while in the propulsion mode, the one or more switches includes a second switch between the inverter and the battery pack, the second switch connects the inverter to the battery pack while in the propulsion mode, and the second switch disconnects the inverter from the battery pack while in the charge mode.

In one or more embodiments of the system, the electric motor is a four-terminal machine with a common terminal, the one or more switches includes a first switch between the onboard charging module and the capacitor, the first switch connects the capacitor to the onboard charging module while in the propulsion mode, the first switch disconnects the capacitor from the onboard charging module while in the charge mode, the one or more switches includes a second switch between the common terminal and the capacitor, the second switch disconnects the common terminal from the capacitor while in the propulsion mode, and the second switch connects the common terminal to the capacitor while in the charge mode.

In one or more embodiments of the system, the electric motor is a four-terminal machine with a common terminal, the one or more switches includes a first switch between the onboard charging module and the common terminal, the first switch connects the common terminal to the onboard charging module while in the charge mode, the first switch disconnects the common terminal from the onboard charging module while in the propulsion mode, the one or more switches includes a second switch between the onboard charging module and the battery pack, the second switch disconnects the onboard charging module from the battery pack while in the charge mode, and the second switch connects the onboard charging module to the battery pack while in the propulsion mode.

In one or more embodiments of the system, the electric motor is a three-terminal machine, the one or more switches includes a first switch between the onboard charging module and the capacitor, the first switch connects the capacitor to the onboard charging module while in the propulsion mode, the first switch disconnects the capacitor from the onboard charging module while in the charge mode, the one or more switches includes two second switches between the capacitor and a first terminal and a second terminal of the three-terminal machine respectively through the inverter, the two second switches connect the capacitor from a first winding the one or more winding and a second winding the one or more winding while in the charge mode, and the two second switches disconnect the capacitor to the first winding and the second winding while in the propulsion mode.

In one or more embodiments of the system, the electric motor is a three-terminal machine, the one or more switches includes two first switches between the onboard charging module and two winding of the three-terminal machine, the two first switches connect the onboard charging module to the two winding while in the charge mode, the two first switches disconnect the onboard charging module from the two winding while in the propulsion mode, the one or more switches includes a second switch between the inverter and the battery pack, the second switch disconnect the inverter from the battery pack while in the charge mode, and the second switch connect the inverter to the battery pack while in the propulsion mode.

In one or more embodiments of the system, the electric motor is a three-terminal machine, the one or more switches includes two first switches between the onboard charging module and two terminals of the three-terminal machine, the two first switches connect the onboard charging module to one of the two terminals while in the charge mode, the two first switches disconnect the onboard charging module from two winding of the one or more winding while in the propulsion mode, the one or more switches includes a second switch between the onboard charging module and the battery pack, the second switch connects the onboard charging module to the battery pack while in the charge mode, and the second switch disconnects the onboard charging module from the battery pack while in the propulsion mode.

In one or more embodiments of the system, the electric motor is a four-terminal machine with a common terminal, the one or more switches includes a first switch between the common terminal and the capacitor, the first switch disconnects the common terminal from the capacitor while in the propulsion mode, and the first switch connects the common terminal to the capacitor while in the charge mode.

A method for active power decoupling is provided herein. The method includes storing electrical energy at a pack voltage in a battery pack, converting an alternating current line signal to a rectified signal in an onboard charging module. The rectified signal has a ripple. The method includes converting the pack voltage into a multi-phase alternating current signal in an inverter while in a propulsion mode, transferring the rectified signal to the battery pack while in a charge mode, converting the multi-phase alternating current signal into a rotational torque in an electric motor while in the propulsion mode, wherein the electric motor has a plurality of windings in multiple phases, filtering the ripple in the rectified signal with one or more windings of the plurality of windings prior to the rectified signal reaching the battery pack while in the charge mode, and routing the rectified signal through a capacitor and the one or more winding of the electric motor with one or more switches to filter the ripple while in the charge mode.

In one or more embodiments of the method, the capacitor is between the onboard charging module and the electric motor, the electric motor is a three-terminal machine, and the one or more switches is a first switch between the capacitor and one terminal of the three-terminal machine. The method further includes connecting the capacitor to the one terminal through the first switch while in the charge mode, and disconnecting the capacitor from the one terminal through the first switch while in the propulsion mode.

In one or more embodiments of the method, the capacitor is between the onboard charging module and the electric motor, the electric motor is a three-terminal machine, and the one or more switches is two switches between the capacitor and two terminals of the three-terminal machine, respectively. The method further includes connecting the capacitor to one of the two terminals through the two switches while in the charge mode, and disconnecting the capacitor from the two terminals through the two switches while in the propulsion mode.

In one or more embodiments of the method, the electric motor is a three-terminal machine, and the one or more switches is two switches between the capacitor and two terminals of the three-terminal machine, respectively. The method further includes connecting the capacitor to one of the two terminals through the two switches while in the charge mode, and disconnecting the capacitor from the two terminals through the two switches while in the propulsion mode.

In one or more embodiments of the method, the electric motor is a four-terminal machine with a common terminal, the one or more switches includes a first switch between the onboard charging module and the common terminal, and the one or more switches includes a second switch between the inverter and the battery pack. The method further includes connecting the common terminal to the onboard charging module through the first switch while in the charge mode, disconnecting the common terminal from the onboard charging module through the first switch while in the propulsion mode, connecting the inverter to the battery pack through the second switch while in the propulsion mode, and disconnecting the inverter from the battery pack through the second switch while in the charge mode.

In one or more embodiments of the method, the electric motor is a four-terminal machine with a common terminal, the one or more switches includes a first switch between the onboard charging module and the capacitor, and the one or more switches includes a second switch between the common terminal and the capacitor. The method further includes connecting the capacitor to the onboard charging module through the first switch while in the propulsion mode, disconnecting the capacitor from the onboard charging module through the first switch while in the charge mode, disconnecting the common terminal from the capacitor through the second switch while in the propulsion mode, and connecting the common terminal to the capacitor through the second switch while in the charge mode.

In one or more embodiments of the method, the electric motor is a four-terminal machine with a common terminal, the one or more switches includes a first switch between the onboard charging module and the common terminal, and the one or more switches includes a second switch between the onboard charging module and the battery pack. The method further includes connecting the common terminal to the onboard charging module through the first switch while in the charge mode, disconnecting the common terminal from the onboard charging module through the first switch while in the propulsion mode, disconnecting the onboard charging module from the battery pack through the second switch while in the charge mode, and connecting the onboard charging module to the battery pack through the second switch while in the propulsion mode.

In one or more embodiments of the method, the electric motor is a three-terminal machine, the one or more switches includes a first switch between the onboard charging module and the capacitor, and the one or more switches includes two second switches between the capacitor and a first terminal and a second terminal of the three-terminal machine respectively through the inverter. The method further includes connecting the capacitor to the onboard charging module through the first switch while in the propulsion mode, disconnecting the capacitor from the onboard charging module through the first switch while in the charge mode, disconnecting the capacitor from a first winding of the one or more windings and a second winding of the one or more windings through the two second switches while in the propulsion mode, and connecting the capacitor to the first winding and the second winding through the two second switches while in the charge mode.

A vehicle is provided herein. The vehicle includes a battery pack, an onboard charging module, an inverter, an electric motor, a capacitor, one or more switches, and a controller. The battery pack is operational to store electrical energy at a pack voltage. The onboard charging module is coupled to the battery pack and is operational to convert an alternating current line signal to a rectified signal. The rectified signal has a ripple. The inverter is coupled to the onboard charging module and the battery pack. The inverter is operational to convert the pack voltage into a multi-phase alternating current signal while in a propulsion mode, and transfer the rectified signal to the battery pack while in a charge mode. The electric motor has a plurality of windings in multiple phases and is coupled to the inverter. The electric motor is operational to convert the multi-phase alternating current signal into a rotational torque while in the propulsion mode, and one or more windings of the plurality of windings is operational to filter the ripple in the rectified signal while in the charge mode. The capacitor coupled to the onboard charging module. The one or more switches are coupled to the onboard charging module and are operational to route the rectified signal through the capacitor and the one or more winding of the electric motor to filter the ripple while in the charge mode. The controller is operational to control the one or more switches based on the propulsion mode and the charge mode.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a system in accordance with one or more exemplary embodiments.

FIG. 2 is a graph of a charge signal and an active power decoupled charge signal in accordance with one or more exemplary embodiments.

FIG. 3 is a schematic diagram of a first active power decoupling system in accordance with one or more exemplary embodiments.

FIG. 4 is a schematic diagram of a second active power decoupling system in accordance with one or more exemplary embodiments.

FIG. 5 is a schematic diagram of a third active power decoupling system in accordance with one or more exemplary embodiments.

FIG. 6 is a schematic diagram of a fourth active power decoupling system in accordance with one or more exemplary embodiments.

FIG. 7 is a schematic diagram of a fifth active power decoupling system in accordance with one or more exemplary embodiments.

FIG. 8 is a schematic diagram of a sixth active power decoupling system in accordance with one or more exemplary embodiments.

FIG. 9 is a schematic diagram of a seventh active power decoupling system in accordance with one or more exemplary embodiments.

FIG. 10 is a schematic diagram of an eighth active power decoupling system in accordance with one or more exemplary embodiments.

FIG. 11 is a schematic diagram of a ninth active power decoupling system in accordance with one or more exemplary embodiments.

FIG. 12 is a schematic diagram of a tenth active power decoupling system in accordance with one or more exemplary embodiments.

FIG. 13 is a flow diagram of a method for active power decoupling is accordance with one or more exemplary embodiments.

### DETAILED DESCRIPTION

Embodiments of the disclosure provide an active power decoupling system and/or method for a single-stage on-board charger module (OBCM) to remove low-frequency current ripple at the battery side. The single-stage OBCM excels in size and energy efficiency compared to a two-stage OBCM. However, the single-stage OBCM output has higher current ripple than the two-stage OBCM so a power decoupling device is adding to prevent battery degradation. The system/method mitigates the ripple issue by reusing existing inductances in electric motors as part of an inductance-capacitance (LC) filter. The system/method may be applied to other AC-DC, DC-AC, and DC-DC converters.

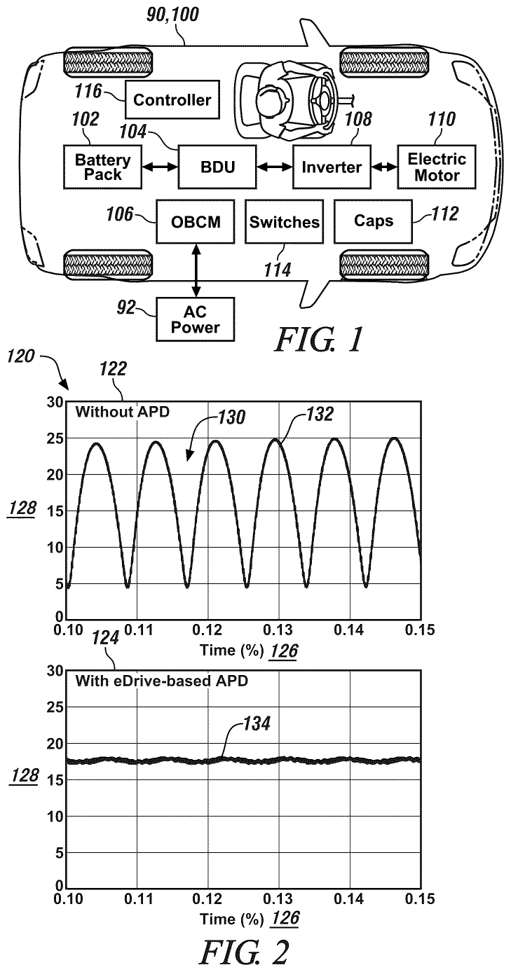

Referring to FIG. 1, a schematic diagram illustrating a context of a system 90 is shown in accordance with one or more exemplary embodiments. The system 90 generally includes an AC (alternating current) power source 92 and a vehicle 100. Electronics of the system 90 include a battery pack 102, a battery disconnect unit 104, an on-board charger module 106, an inverter 108, an electric motor 110 one or more capacitors 112, one or more switches (or relays) 114, and a controller 116 disposed in the vehicle 100.

The AC power source 92 is operational to provide a single-phase AC electrical power to the vehicle 100 to recharge the battery pack 102. In various embodiments, the AC power source 92 may supply single-phase household utility power (e.g., 120 volts AC or 240 volts AC) AC power to the OBCM 106. In some situations, the AC power source 92 may provide 3-phase AC power. Other voltages and/or other numbers of phases may be implemented to meet the design criteria of a particular application.

The vehicle 100 may include, but is not limited to, mobile objects such as a passenger vehicle, a truck, an autonomous vehicle, an electric-powered vehicle, a hybrid vehicle, a motorcycle, a boat, a farm vehicle, a train and/or an aircraft. In some embodiments, the vehicle 100 may include stationary objects such as billboards, kiosks and/or marquees. Other types of vehicles 100 may be implemented to meet the design criteria of a particular application.

The battery pack 102 is a high-voltage battery pack operational to store electrical energy. The battery pack 102 is generally operational to receive electrical power from the OBCM 106 and provide electrical power to the electric motor 110. The battery pack 102 may include multiple battery modules electrically connected in series and/or in parallel. In various embodiments, the battery pack 102 may provide approximately 400 to 1000 volts DC (direct current) electrical potential. Other battery voltages may be implemented to meet the design criteria of a particular application.

The battery disconnect unit (BDU) 104 directly connects the battery pack 102 to the inverter 108. The battery disconnect unit 104 is operational to provide multiple switches (or relays) that connect and disconnect the battery pack 102 from the inverter 108. In various embodiments, the battery disconnect unit 104 may include a main fuse and a pyro switch.

The OBCM 106 is operational to recharge the battery pack 102 while the vehicle 100 is stationary (e.g., parked) and the electric motor 110 is de-energized. The OBCM 106 converts the electrical power received from the AC power source 92 to a high voltage for charging the battery pack 102. Output power of the OBCM 106 typically ranges from 3.6 kilowatt to 22 kilowatts. The OBCM 106 may be characterized by an absence of an output filter capacitor to reduce the ripple.

The inverter 108 is a 3-phase DC to AC inverter. The inverter 108 is operational to convert the DC electrical power received from the battery pack 102 into 3-phase AC electrical power that powers the electric motor 110.

The controller 116 implements a battery controller and an inverter controller. The controller 116 is generally operational to control the switches 114a-114f for charging and discharging the battery pack 102.

The electric motor 110 is a multi-phase electric motor. The electric motor 110 is generally operational to provide rotation and torque to drive wheels of the vehicle 100. The electrical power consumed by the electric motor 110 may be provided by the battery pack 102 and/or an alternator of the vehicle 100. The electric motor 110 include multiple sets of windings, a set for each phase of electrical power. Winding set may be accessed from external to a motor housing by a respective terminal. In some cases, a common terminal is connected to each of the winding sets and is accessible from external to the motor housing.

The capacitors 112 are one or more capacitors coupled among the switches 114, the electric motor 110, the inverter 108, the OBCM 106, and in some designs, the battery disconnect unit 104. The capacitors 112 operate with the inductances of the motor windings to form an LC filter. The LC filter is operational to filter the ripple in the rectified signal produced by the OBCM 106.

The switches 114 are one or more switches coupled among the capacitors 112, the electric motor 110, the inverter 108, the OBCM 106, and in some designs, the battery disconnect unit 104. The switches 114 are coupled to and commanded into either a on (or connected) state and an off (or disconnected) state. A configuration of the switches set the system 90 into one of a propulsion mode and a charge mode.

The controller 116 is a switch controller. The controller 116 is operational to command the switches 114 into the on state and the off state, depending on a status of the electric motor 110 and the OBCM 106.

Referring to FIG. 2, a graph 120 of an example charge signal and an active power decoupled charge signal is shown in accordance with one or more exemplary embodiments. The X-axes 126 of the graphs are in units of seconds. The Y-axes 128 of the graphs are in units of volts.

A sub-graph 122 illustrates an unfiltered charge signal 130 seen at the battery pack 102 from the OBCM 106 without active power decoupling. For a 60 hertz AC signal from the AC power source 92, the unfiltered charge signal 130 includes a pronounced double-line frequency (e.g., 120 Hz) ripple 132. An amplitude of the ripple 132 is almost as great as a peak of the unfiltered charge signal 130.

A sub-graph 124 illustrated a filtered charge signal 134 seen at the battery pack 102 from the OBCM 106 with the active power decoupling. The filtered charge signal 134 lack a majority of the ripple 132 seen in the unfiltered charge signal 130.

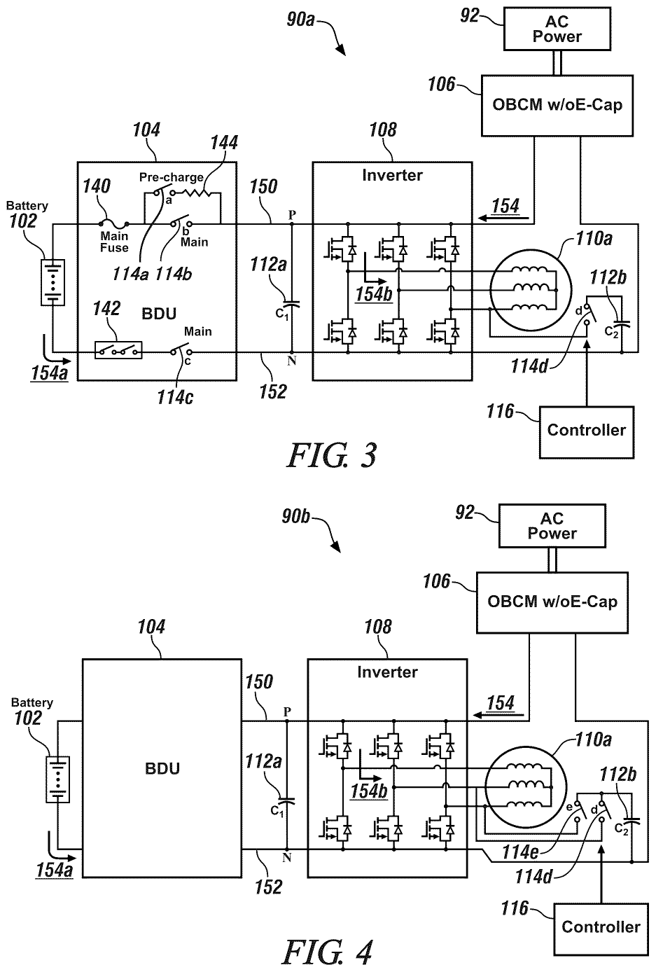

Referring to FIG. 3, a schematic diagram of an example implementation of a first active power decoupling system 90a is shown in accordance with one or more exemplary embodiments. The system 90a includes the AC power source 92, the battery pack 102, the BDU 104, an inverter 108, the OBCM 106, an electric motor 110a, a capacitor 112a, a capacitor 112b, the switches 114a-114d, and the controller 116.

The BDU 104 includes the switches 114a-114c, a main fuse 140, a pyro switch 142 and a pre-charge resistance 144. The switches 114b and 114c controllably connects the battery pack 102 to the inverter 108. The switch 114a controllably bypasses an open switch 114b to pre-charge the battery pack 102. The main fuse 140 is in series between a positive terminal of the battery pack 102 and the switch 114a. The pyro switch is in series between a negative terminal of the battery pack 102 and the switch 114c.

The electric motor 110a is a particular configuration of the electric motor 110 shown in FIG. 1. The electric motor 110a is a three-terminal machine.

The capacitor 112a connects a positive voltage rail 150 and a negative voltage rail 152 among the BDU 104, the inverter 108, and the OBCM 106. The capacitor 112a provides filtering.

The capacitor 112b and the switch 114d are connected in series between the negative voltage rail 152 and one terminal of the electric motor 110a.

Table 1 indicates the on/off status of the switches 114a-114d (and switches 114e and 114f shown in subsequent figures) in both the propulsion mode and the charge mode.

TABLE 1
Switch configurations

| Switches | a | b | c | d, g | e, f |
|---|---|---|---|---|---|
| Propulsion Mode | Precharge | On | On | Off | On |
| Charge Mode | OFF | On | On | On | Off |

In the propulsion mode, the switch 114a may be on (closed) during pre-charging and off (open) while not pre-charging. The switches 114b and 114c are on to connect the battery pack 102 to the inverter 108 in both the propulsion mode and the charge mode. The switch 114d is off (open) in the propulsion mode to disconnect the capacitor 112b from the electric motor 110a.

The switch 114d is on (closed) in the charge mode to connect the capacitor 112b in series with the inductance of the windings in the electric motor 110a. While charging, a charging current 154 (or rectified signal) is received via the OBCM 106. A part 154a of the charging current 154 flows through and charges the battery pack 102. Another part 154b of the charging current 154 flows through the inverter 108 into one of the windings (e.g., the top winding or the middle winding as illustrated) of the electric motor 110a, out of another winding (e.g., the bottom winding as illustrated) of the electric motor 110, through the switch 114d and the capacitor 112b, and back to the OBCM 106. The series LC filter created by the winding and the capacitor 112b filter the ripple in the charging current 154 to provide a clean charge current 154a.

Referring to FIG. 4, a schematic diagram of an example implementation of a second active power decoupling system 90b is shown in accordance with one or more exemplary embodiments. The system 90b is a variation of the system 90a. The system 90b includes the AC power source 92, the battery pack 102, the BDU 104, the inverter 108, the OBCM 106, the electric motor 110a, the capacitor 112a, the capacitor 112b, the switches 114a-114d, an additional switch 114e, and the controller 116.

If the electric motor 110a is a low-inductance motor, the switch 114e is between the capacitor 112b and a third terminal of the electric motor 110a.

The clean charge current 154a flows through and charges the battery pack 102. The charge low-frequency ripple current 154b flows through the inverter 108 into one windings (e.g., the top winding on the top terminal as illustrated) of the electric motor 110a, out of the other two windings (e.g., the middle winding and the bottom winding on the lower two terminals as illustrated), one winding at time, through the respective switches 114e and 114d, through the capacitor 112b, and back to the OBCM 106. The LC filter created by the motor winding and the capacitor 112b filter the ripple in the charging current 154 to provide a clean charge current 154a. The series LC filter created by the winding and the capacitor 112b filter the ripple in the charging current 154 to provide a clean charge current 154a.

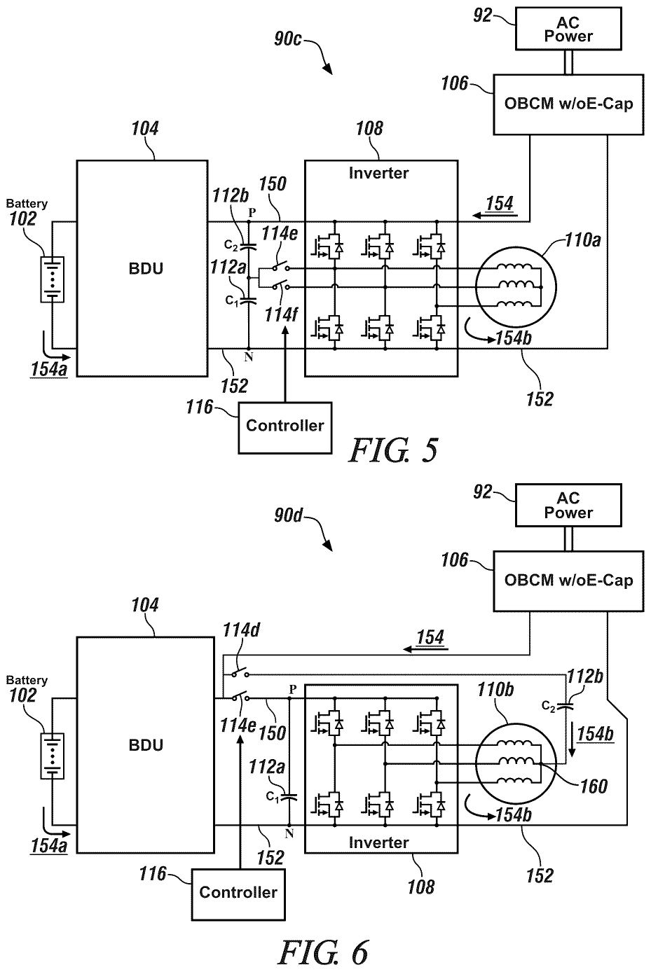

Referring to FIG. 5, a schematic diagram of an example implementation of a third active power decoupling system 90c is shown in accordance with one or more exemplary embodiments. The system 90c is a variation of the system 90a and/or 90b. The system 90c includes the AC power source 92, the battery pack 102, the BDU 104, the inverter 108, the OBCM 106, the electric motor 110a, the capacitor 112a, the capacitor 112b, the switches 114a-114c, the switches 114e and 114f, and the controller 116.

The capacitor 112a and the capacitor 112b are connected in series at a center node 156. The capacitors 112a-112b connect between the positive voltage rail 150 and the negative voltage rail 152, with the capacitor 112b at the positive voltage rail 150.

The clean charge current 154a flows through and charges the battery pack 102. The charge current 154b flows through the capacitor 112b, through the switches 114e-114f, into two windings (e.g., the top winding and the middle winding as illustrated) of the electric motor 110a, out of the other windings (e.g., the bottom winding as illustrated), and back to the OBCM 106. The series LC filter created by the windings and the capacitor 112b filter the ripple in the charging current 154 to provide a clean charge current 154a.

Referring to FIG. 6, a schematic diagram of an example implementation of a fourth active power decoupling system 90d is shown in accordance with one or more exemplary embodiments. The system 90d is a variation of the system 90a, 90b and/or 90c. The system 90d includes the AC power source 92, the battery pack 102, the BDU 104, the inverter 108, the OBCM 106, an electric motor 110b, the capacitor 112a, the capacitor 112b, the switches 114a-114e, and the controller 116.

The electric motor 110b is a variation of the electric motor 110 shown in FIG. 1. The electric motor 110b is a four-terminal machine with a common terminal 160.

The clean charge current 154a flows through and charges the battery pack 102. The charge current 154b flows through the switch 114d, through the capacitor 112b, through one or more of the windings of the electric motor 110b, through the inverter 108, and back to the OBCM 106. The series LC filter created by the windings and the capacitor 112b filter the ripple in the charging current 154 to provide a clean charge current 154a.

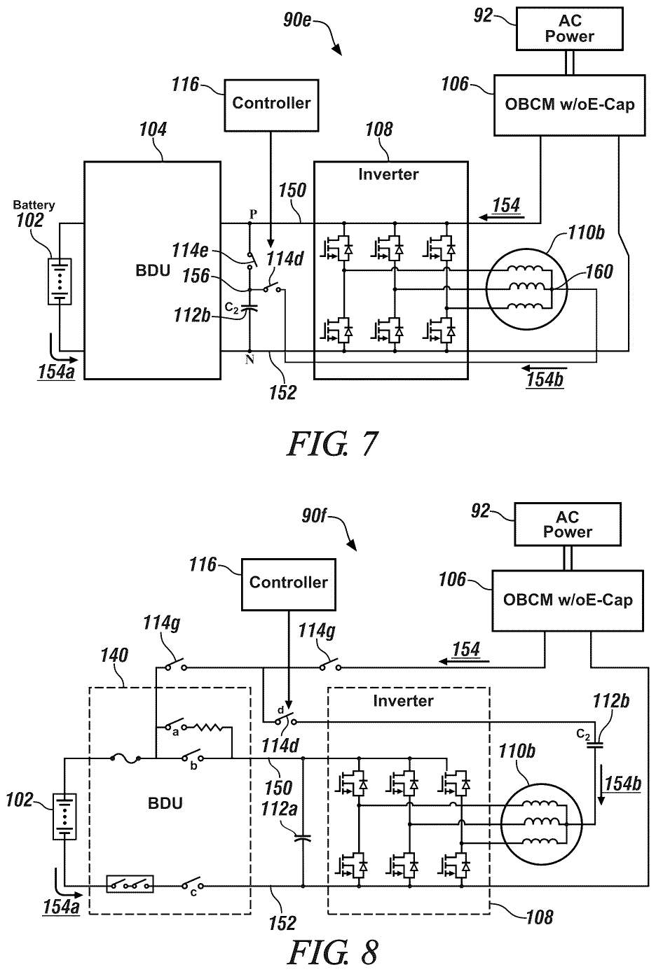

Referring to FIG. 7, a schematic diagram of an example implementation of a fifth active power decoupling system 90e is shown in accordance with one or more exemplary embodiments. The system 90e is a variation of the system 90a, 90b, 90c and/or 90d. The system 90e includes the AC power source 92, the battery pack 102, the BDU 104, the inverter 108, the OBCM 106, the electric motor 110b, the capacitor 112b, the switches 114a-114e, and the controller 116.

The switch 114e may be a super conjunction-based switch. The switch 114e and the capacitor 112b are connected in series at the center node 156. The capacitor 112b and the switch 114e are connected between the positive voltage rail 150 and the negative voltage rail 152, with the switch 114e at the positive voltage rail 150. The switch 114e is open and the switch 114d is closed during the charge mode. The switch 114e is closed and the switch 114d is open during the propulsion mode.

The clean charge current 154a flows through and charges the battery pack 102. The charge current 154b flows through one or more of the windings of the electric motor 110b, out the common terminal 160, through the switch 114d, through the capacitor 112b, and back to the OBCM 106. The series LC filter created by the windings and the capacitor 112b filter the ripple in the charging current 154 to provide a clean charge current 154a.

Referring to FIG. 8, a schematic diagram of an example implementation of a sixth active power decoupling system 90f is shown in accordance with one or more exemplary embodiments. The system 90f is a variation of the system 90a, 90b, 90c, 90d and/or 90e. The system 90f includes the AC power source 92, the battery pack 102, the BDU 104, the inverter 108, the OBCM 106, an electric motor 110b, the capacitor 112a, the capacitor 112b, the switches 114a-114d, and the controller 116.

The clean charge current 154a flows through and charges the battery pack 102. The charge current 154b flows through the switch 114d, through the capacitor 112b, through one or more of the windings of the electric motor 110b, through the inverter 108, and back to the OBCM 106. The series LC filter created by the windings and the capacitor 112b filter the ripple in the charging current 154 to provide a clean charge current 154a.

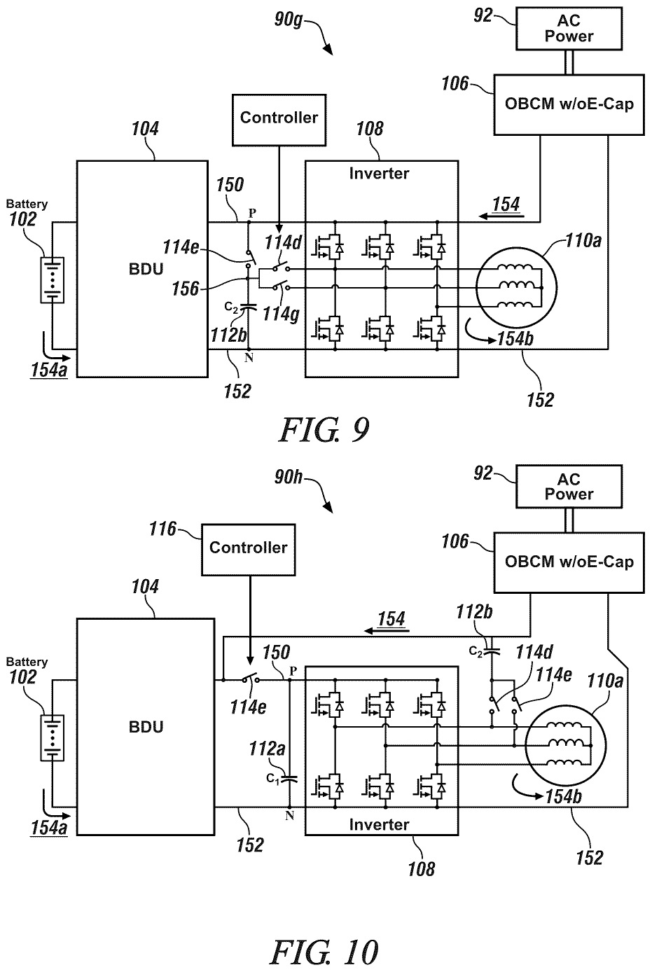

Referring to FIG. 9, a schematic diagram of an example implementation of a seventh active power decoupling system 90g is shown in accordance with one or more exemplary embodiments. The system 90g is a variation of the system 90a, 90b, 90c, 90d, 90e and/or 90f. The system 90g includes the AC power source 92, the battery pack 102, the BDU 104, the inverter 108, the OBCM 106, the electric motor 110a, the capacitor 112b, the switches 114a-114g, and the controller 116.

The switch 114e and the capacitor 112b are connected in series at a center node 156. The capacitor 112b and the switch 114e are connect between the positive voltage rail 150 and the negative voltage rail 152, with the switch 114e at the positive voltage rail 150.

The clean charge current 154a flows through and charges the battery pack 102. The charge current 154b flows through inverter switches of leg C, into the third winding (e.g., the bottom winding as illustrated) of the electric motor 110a, out one of the other two windings (e.g., the top winding or the middle winding as illustrated), through the switches 114d or 114g, depending on a position of the rotor in the electric motor 110a, through capacitor 112b, and back to the OBCM 106. The parallel LC filter created by the windings and the capacitor 112b filter the ripple in the charging current 154 to provide a clean charge current 154a.

Referring to FIG. 10, a schematic diagram of an example implementation of an eighth active power decoupling system 90h is shown in accordance with one or more exemplary embodiments. The system 90h is a variation of the system 90a, 90b, 90c, 90d, 90e, 90f and/or 90g. The system 90h includes the AC power source 92, the battery pack 102, the BDU 104, the inverter 108, the OBCM 106, the electric motor 110a, the capacitor 112a, the capacitor 112b, the switches 114a-114f, and the controller 116.

The clean charge current 154a flows through and charges the battery pack 102. The charge current 154b flows through capacitor 112b, through the switches 114d and 114e to two windings (e.g., the top winding and the middle winding as illustrated) of the electric motor 110a, out of the other windings (e.g., the bottom winding as illustrated), through the inverter 108, and back to the OBCM 106. The series LC filter created by the windings and the capacitor 112b filter the ripple in the charging current 154 to provide a clean charge current 154a.

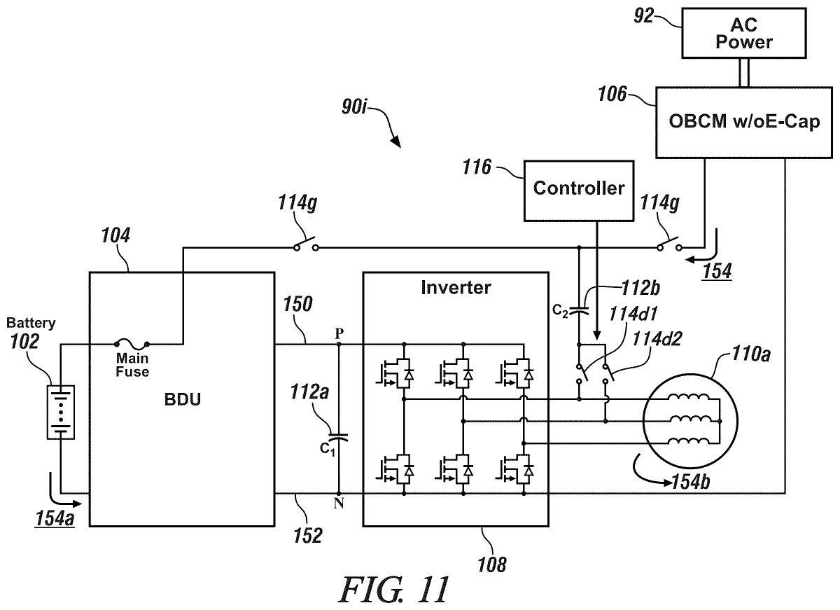

Referring to FIG. 11, a schematic diagram of an example implementation of a ninth active power decoupling system 90i is shown in accordance with one or more exemplary embodiments. The system 90i is a variation of the system 90a, 90b, 90c, 90d, 90e, 90f, 90g and/or 90h. The system 90i includes the AC power source 92, the battery pack 102, the BDU 104, the inverter 108, the OBCM 106, the electric motor 110a, the capacitor 112a, the capacitor 112b the switches 114a-114d2 and 114g, and the controller 116. In various embodiments, one or both of the switches 114g may be implemented.

The clean charge current 154a flows through the switches 114g and charges the battery pack 102. The charge current 154b flows through capacitor 112b, through one of the switches 114d1 and 114d2, depending on a position of the rotor in the electric motor 110, to a corresponding one of the windings (e.g., the top winding or the middle winding as illustrated) of the electric motor 110a, out of the other windings (e.g., the bottom winding as illustrated), through the inverter 108, and back to the OBCM 106. The series LC filter created by the windings and the capacitor 112b filter the ripple in the charging current 154 to provide a clean charge current 154a.

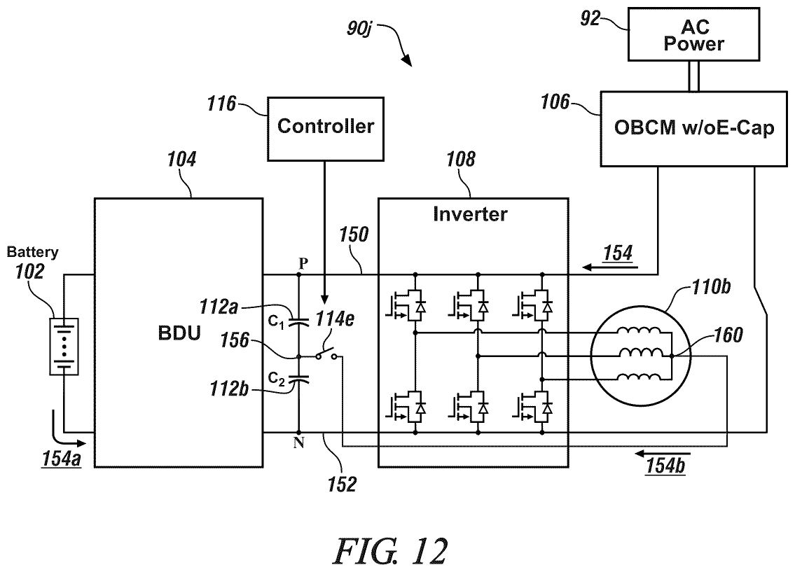

Referring to FIG. 12, a schematic diagram of an example implementation of a tenth active power decoupling system 90j is shown in accordance with one or more exemplary embodiments. The system 90j is a variation of the system 90a, 90b, 90c, 90d, 90e, 90f, 90g, 90h and/or 90i. The system 90j includes the AC power source 92, the battery pack 102, the BDU 104, the inverter 108, the OBCM 106, the electric motor 110b, the capacitors 112a and 112b, the switches 114a-114c and 114e, and the controller 116.

The capacitor 112a and the capacitor 112b are connected in series at the center node 156. The capacitor 112b connect and the capacitor 112a are between the positive voltage rail 150 and the negative voltage rail 152, with the capacitor 112a at the positive voltage rail 150.

The clean charge current 154a flows through and charges the battery pack 102. The charge current 154b flows through one of the windings of the electric motor 110b (depending on a position of the rotor), out the common terminal 160, through the switch 114e, through the capacitor 112b, and back to the OBCM 106. The series LC filter created by the windings and the capacitor 112b filter the ripple in the charging current 154 to provide a clean charge current 154a.

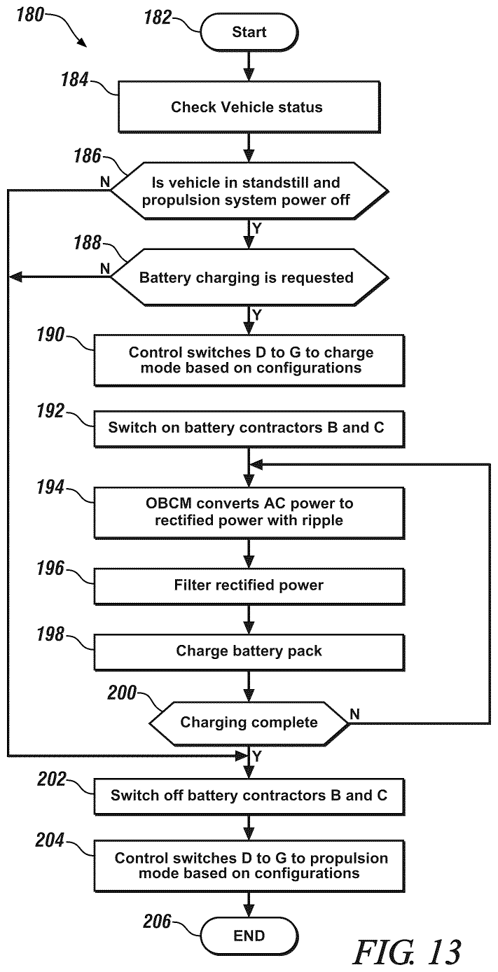

Referring to FIG. 13, a flow diagram of an example method 180 for active power decoupling is shown in accordance with one or more exemplary embodiments. The method (or process) 180 is implemented by the system 90. The method 180 includes steps 182 to 206, as illustrated. The sequence of steps is shown as a representative example. Other step orders may be implemented to meet the criteria of a particular application.

The method 180 starts in the step 182. In the step 184, a check is performed of the vehicle status. If the vehicle status is at standstill and the propulsion system is power off in the decision step 186, the method 180 continues with the decision step 188. Otherwise, the method 180 continues with the step 202.

In the decision step 188, a check is made to determine if a battery charging is requested. If the battery charge is requested, the method 180 continues with the step 190. Otherwise, the method 180 continues with the step 202.

In the step 190, the switches 114d and 114g are controlled to the charge mode based on the configuration of the system 90 (e.g., 90a, 90b, 90c, etc.). The battery contactors (e.g., switches 114b and 114c) are switched on in the step 192. The OBCM 106 converts the AC power received from the AC power source 92 into rectified power with the ripple in the step 194. The rectified power is filtered in the step 196. The filtered rectified power is used to charge the battery pack 102 in the step 198.

In decision step 200, a check is made to determine if the charging is complete. If not complete, the method 180 returns to the step 194 and the OBCM 106 continues to convert the AC power. Once the charging is complete, the method continues with the step 202.

In the step 202, the battery contactors B and C (e.g., the switches 114b and 114c) are switched off. The controller 116 may command the switches 114d and 114g to the off condition in the step 204. The method 180 subsequently ends in the step 206.

Embodiments of the disclosure generally leverage an electric motor and inverter to eliminate the double-line frequency ripple. In various designs, a filter capacitor normally in the OBCM may be eliminated. The system reuses an inverter capacitor (DC-link film cap), inverter switches, and electric motor windings to absorb current/voltage ripples before flowing to the battery pack. The system is compatible with a three-terminal machine drive and a four-terminal machine drive based on active power decoupling the OBCM. An appropriate motor winding may be selected for the filtering depending on a rotor position. Control of the switches may be interleaved to further reduce noise and ripples.

The double-line frequency ripple may be removed using an existing inverter and electric motor with a few additional switches and an additional capacitor. Removing the electrolytic filter capacitor in the OBCM provides for a lifetime improvement, a size reduction, a weight reduction, and a packaging reduction. Embodiments of the system effectively remove the double-line frequency current ripple to improve battery pack lifetime and reduce battery degradation. Being of lower operating current and voltage, the topology of the system allows use of lower capacity switches and/or relays.

Embodiments of the disclosure generally provide an active power decoupling system that includes a battery pack, an onboard charging module, an inverter, an electric motor, a capacitor, and one or more switches. The battery pack generally stores electrical energy at a pack voltage. The onboard charging module converts an alternating current line signal received from an external source to a rectified signal, where the rectified signal has a ripple. The inverter converts the pack voltage into a multi-phase alternating current signal while in a propulsion mode, and transfers the rectified signal to the battery pack while in a charge mode. The electric motor has multiple windings in multiple phases. The electric motor converts the multi-phase alternating current signal into a rotational torque while in the propulsion mode, and one or more of the windings is used to filter the ripple in the rectified signal while in the charge mode. The switches route the rectified signal through the capacitor and the one or more winding of the electric motor to filter the ripple while in the charge mode.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. An active power decoupling system comprising:
a battery pack operational to store electrical energy at a pack voltage;
an onboard charging module coupled to the battery pack and operational to convert an alternating current line signal to a rectified signal, wherein the rectified signal has a ripple;
an inverter coupled to the onboard charging module and the battery pack, wherein the inverter is operational to:
convert the pack voltage into a multi-phase alternating current signal while in a propulsion mode; and
transfer the rectified signal to the battery pack while in a charge mode;
an electric motor with a plurality of windings in multiple phases and coupled to the inverter, wherein:
the electric motor is operational to convert the multi-phase alternating current signal into a rotational torque while in the propulsion mode; and
one or more windings of the plurality of windings is operational to filter the ripple in the rectified signal while in the charge mode;
a capacitor coupled to the onboard charging module; and
one or more switches coupled to the onboard charging module and operational to route the rectified signal through the capacitor and the one or more winding of the electric motor to filter the ripple while in the charge mode.

2. The active power decoupling system according to claim 1, wherein:
the capacitor is between the onboard charging module and the electric motor;
the electric motor is a three-terminal machine;
the one or more switches is a first switch between the capacitor and one terminal of the three-terminal machine;
the first switch connects the capacitor to the one terminal while in the charge mode; and
the first switch disconnects the capacitor from the one terminal while in the propulsion mode.

3. The active power decoupling system according to claim 1, wherein:
the capacitor is between the onboard charging module and the electric motor;
the electric motor is a three-terminal machine;
the one or more switches is two switches between the capacitor and two terminals of the three-terminal machine, respectively;
the two switches connect the capacitor to one of the two terminals while in the charge mode; and
the two switches disconnects the capacitor from the two terminals while in the propulsion mode.

4. The active power decoupling system according to claim 1, wherein:
the electric motor is a three-terminal machine;
the one or more switches is two switches between the capacitor and two terminals of the three-terminal machine, respectively;
the two switches connect the capacitor to one of the two terminals while in the charge mode; and
the two switches disconnect the capacitor from the two terminals while in the propulsion mode.

5. The active power decoupling system according to claim 1, wherein:
the electric motor is a four-terminal machine with a common terminal;
the one or more switches includes a first switch between the onboard charging module and the common terminal;
the first switch connects the common terminal to the onboard charging module while in the charge mode;
the first switch disconnects the common terminal from the onboard charging module while in the propulsion mode;
the one or more switches includes a second switch between the inverter and the battery pack;
the second switch connects the inverter to the battery pack while in the propulsion mode; and
the second switch disconnects the inverter from the battery pack while in the charge mode.

6. The active power decoupling system according to claim 1, wherein:
the electric motor is a four-terminal machine with a common terminal;
the one or more switches includes a first switch between the onboard charging module and the capacitor;
the first switch connects the capacitor to the onboard charging module while in the propulsion mode;
the first switch disconnects the capacitor from the onboard charging module while in the charge mode;
the one or more switches includes a second switch between the common terminal and the capacitor;
the second switch disconnects the common terminal from the capacitor while in the propulsion mode; and
the second switch connects the common terminal to the capacitor while in the charge mode.

7. The active power decoupling system according to claim 1, wherein:
the electric motor is a four-terminal machine with a common terminal;
the one or more switches includes a first switch between the onboard charging module and the common terminal;
the first switch connects the common terminal to the onboard charging module while in the charge mode;
the first switch disconnects the common terminal from the onboard charging module while in the propulsion mode;
the one or more switches includes a second switch between the onboard charging module and the battery pack;
the second switch disconnects the onboard charging module from the battery pack while in the charge mode; and
the second switch connects the onboard charging module to the battery pack while in the propulsion mode.

8. The active power decoupling system according to claim 1, wherein:
the electric motor is a three-terminal machine;
the one or more switches includes a first switch between the onboard charging module and the capacitor;
the first switch connects the capacitor to the onboard charging module while in the propulsion mode;
the first switch disconnects the capacitor from the onboard charging module while in the charge mode;
the one or more switches includes two second switches between the capacitor and a first terminal and a second terminal of the three-terminal machine respectively through the inverter;
the two second switches connect the capacitor from a first winding the one or more winding and a second winding the one or more winding while in the charge mode; and
the two second switches disconnect the capacitor to the first winding and the second winding while in the propulsion mode.

9. The active power decoupling system according to claim 1, wherein:
the electric motor is a three-terminal machine;
the one or more switches includes two first switches between the onboard charging module and two winding of the three-terminal machine;
the two first switches connect the onboard charging module to the two winding while in the charge mode;
the two first switches disconnect the onboard charging module from the two winding while in the propulsion mode;
the one or more switches includes a second switch between the inverter and the battery pack;
the second switch disconnect the inverter from the battery pack while in the charge mode; and
the second switch connect the inverter to the battery pack while in the propulsion mode.

10. The active power decoupling system according to claim 1, wherein:
the electric motor is a three-terminal machine;
the one or more switches includes two first switches between the onboard charging module and two terminals of the three-terminal machine;
the two first switches connect the onboard charging module to one of the two terminals while in the charge mode;
the two first switches disconnect the onboard charging module from two winding of the one or more winding while in the propulsion mode;
the one or more switches includes a second switch between the onboard charging module and the battery pack;
the second switch connects the onboard charging module to the battery pack while in the charge mode; and
the second switch disconnects the onboard charging module from the battery pack while in the propulsion mode.

11. The active power decoupling system according to claim 1, wherein:
the electric motor is a four-terminal machine with a common terminal;
the one or more switches includes a first switch between the common terminal and the capacitor;
the first switch disconnects the common terminal from the capacitor while in the propulsion mode; and
the first switch connects the common terminal to the capacitor while in the charge mode.

12. A method for active power decoupling comprising:
storing electrical energy at a pack voltage in a battery pack;
converting an alternating current line signal to a rectified signal in an onboard charging module, wherein the rectified signal has a ripple;
converting the pack voltage into a multi-phase alternating current signal in an inverter while in a propulsion mode;
transferring the rectified signal to the battery pack while in a charge mode;
converting the multi-phase alternating current signal into a rotational torque in an electric motor while in the propulsion mode, wherein the electric motor has a plurality of windings in multiple phases;
filtering the ripple in the rectified signal with one or more windings of the plurality of windings prior to the rectified signal reaching the battery pack while in the charge mode; and
routing the rectified signal through a capacitor and the one or more winding of the electric motor with one or more switches to filter the ripple while in the charge mode.

13. The method according to claim 12, wherein:
the capacitor is between the onboard charging module and the electric motor;
the electric motor is a three-terminal machine; and
the one or more switches is a first switch between the capacitor and one terminal of the three-terminal machine; and
the method further comprises:
connecting the capacitor to the one terminal through the first switch while in the charge mode; and
disconnecting the capacitor from the one terminal through the first switch while in the propulsion mode.

14. The method according to claim 12, wherein:
the capacitor is between the onboard charging module and the electric motor;
the electric motor is a three-terminal machine; and
the one or more switches is two switches between the capacitor and two terminals of the three-terminal machine, respectively; and
the method further comprising:
connecting the capacitor to one of the two terminals through the two switches while in the charge mode; and
disconnecting the capacitor from the two terminals through the two switches while in the propulsion mode.

15. The method according to claim 12, wherein:
the electric motor is a three-terminal machine; and
the one or more switches is two switches between the capacitor and two terminals of the three-terminal machine, respectively; and
the method further comprises:
connecting the capacitor to one of the two terminals through the two switches while in the charge mode; and
disconnecting the capacitor from the two terminals through the two switches while in the propulsion mode.

16. The method according to claim 12, wherein:
the electric motor is a four-terminal machine with a common terminal;
the one or more switches includes a first switch between the onboard charging module and the common terminal; and
the one or more switches includes a second switch between the inverter and the battery pack; and
the method further comprises:
connecting the common terminal to the onboard charging module through the first switch while in the charge mode;
disconnecting the common terminal from the onboard charging module through the first switch while in the propulsion mode;
connecting the inverter to the battery pack through the second switch while in the propulsion mode; and
disconnecting the inverter from the battery pack through the second switch while in the charge mode.

17. The method according to claim 12, wherein:
the electric motor is a four-terminal machine with a common terminal;
the one or more switches includes a first switch between the onboard charging module and the capacitor; and
the one or more switches includes a second switch between the common terminal and the capacitor; and
the method further comprises:
connecting the capacitor to the onboard charging module through the first switch while in the propulsion mode;
disconnecting the capacitor from the onboard charging module through the first switch while in the charge mode;
disconnecting the common terminal from the capacitor through the second switch while in the propulsion mode; and
connecting the common terminal to the capacitor through the second switch while in the charge mode.

18. The method according to claim 12, wherein:
the electric motor is a four-terminal machine with a common terminal;
the one or more switches includes a first switch between the onboard charging module and the common terminal; and
the one or more switches includes a second switch between the onboard charging module and the battery pack; and
the method further comprises:
connecting the common terminal to the onboard charging module through the first switch while in the charge mode;
disconnecting the common terminal from the onboard charging module through the first switch while in the propulsion mode;
disconnecting the onboard charging module from the battery pack through the second switch while in the charge mode; and
connecting the onboard charging module to the battery pack through the second switch while in the propulsion mode.

19. The method according to claim 12, wherein:
the electric motor is a three-terminal machine;
the one or more switches includes a first switch between the onboard charging module and the capacitor; and
the one or more switches includes two second switches between the capacitor and a first terminal and a second terminal of the three-terminal machine respectively through the inverter; and
the method further comprises:
connecting the capacitor to the onboard charging module through the first switch while in the propulsion mode;
disconnecting the capacitor from the onboard charging module through the first switch while in the charge mode;
disconnecting the capacitor from a first winding of the one or more windings and a second winding of the one or more windings through the two second switches while in the propulsion mode; and
connecting the capacitor to the first winding and the second winding through the two second switches while in the charge mode.

20. A vehicle comprising:
a battery pack operational to store electrical energy at a pack voltage;
an onboard charging module coupled to the battery pack and operational to convert an alternating current line signal to a rectified signal, wherein the rectified signal has a ripple;
an inverter coupled to the onboard charging module and the battery pack, wherein the inverter is operational to:
convert the pack voltage into a multi-phase alternating current signal while in a propulsion mode; and
transfer the rectified signal to the battery pack while in a charge mode;
an electric motor with a plurality of windings in multiple phases and coupled to the inverter, wherein:
the electric motor is operational to convert the multi-phase alternating current signal into a rotational torque while in the propulsion mode; and
one or more windings of the plurality of windings is operational to filter the ripple in the rectified signal while in the charge mode;
a capacitor coupled to the onboard charging module;
one or more switches coupled to the onboard charging module and operational to route the rectified signal through the capacitor and the one or more winding of the electric motor to filter the ripple while in the charge mode; and
a controller operational to control the one or more switches based on the propulsion mode and the charge mode.
